(19) United States
(12) Patent Application Publication
(10) Pub. No.: US 2009/0003634 A1
(43) Pub. Date: Jan. 1, 2009

(54) SPEAKER ARRAY APPARATUS, MICROPHONE ARRAY APPARATUS, AND SIGNAL PROCESSING METHODS THEREFOR

(75) Inventor: Koji Kushida, Hamamatsu-shi (JP)

Correspondence Address: ROSSI, KIMMS & McDOWELL LLP., 20609 Gordon Park Square, Suite 150, Ashburn, VA, 20147, US

(73) Assignee: YAMAHA CORPORATION, Hamamatsu-shi (JP)

(21) Appl. No.: 12/145,609

(22) Filed: Jun. 25, 2008

(30) Foreign Application Priority Data
Jun. 26, 2007 (JP) 2007-167737

(51) Int. Cl. H04R 5/02

(52) U.S. Cl. 381/300; 381/92

(57) ABSTRACT

A speaker array apparatus capable of carrying out directivity control over a wide frequency range with reduced processing load. In the speaker array apparatus, an audio signal input from a signal input unit is divided into components by a signal divider unit to generate divided audio signals of different frequency ranges. The divided audio signals are amplified by amplifier units of a signal processing unit with gains set in accordance with window functions set to the amplifier units, and a sound emission unit emits sounds based on the amplified audio signals, whereby desired directional characteristics can be attained over a wide frequency range and an amount of calculation in the processing by the signal processing unit can be reduced.

### BACKGROUND OF THE INVENTION

1. Field of the Invention

The present invention relates to a speaker array apparatus and a microphone array apparatus having an improved directivity, and signal processing methods therefor.

2. Description of the Related Art

As a speaker system with an improved directivity, i.e., a narrow directivity, there is for example known a speaker array having a plurality of speakers mounted therein. The speaker array is adapted to control a sound directivity state by controlling the amplitude, phase, and/or other characteristics of sound to be emitted from the speakers, whereby beamed sound can be emitted toward a desired place. Since the beamed sound can be transmitted with less attenuation even to a remote place, the speaker array is often used in a large hall or the like.

As a result of the directivity state control, on the other hand, the sound frequency range is likely to be narrowed. To obviate this, the following exemplary documents disclose techniques to optimally control the phase and amplitude of an input audio signal at individual frequency points by using FIR (finite impulse response) filters.

Japanese Laid-open Patent Publication No. 2-239798

Tetsuki TANIGUCHI, Kiyoshi NISHIKAWA, and Masaki AMANO, Wideband Beam forming by Means of Multiple Band-Division Using Dolph-Chebyshev Spatial Filters, The Transactions of the Institute of Electronics, Information and Communication Engineers, December 1995, Vol. J78-A, No. 12, pp. 1576-1584

Mitsuyoshi OHYA, Kiyoshi NISHIKAWA, Directional Array Speaker with the Specified Beam Direction by means of a Band-Division Design, 10th Digital Signal Processing Symposium, Nov. 1-2, 1995, pp. 59-64

With the phase and amplitude control using FIR filters at individual frequency points, however, a calculation amount becomes enormous, and an extremely large processing load is applied to, for example, a DSP (digital signal processor).

### SUMMARY OF THE INVENTION

The present invention provides a speaker array apparatus, a microphone array apparatus, and a signal processing method, which make it possible to carry out directivity control over a wide frequency range with a reduced processing load.

According to a first aspect of this invention, there is provided a speaker array apparatus comprising a signal divider unit adapted to divide an input audio signal at at least one set value in terms of frequency characteristic into a plurality of audio signal components to thereby generate a plurality of divided audio signals of different frequency ranges, a signal processing unit including a plurality of amplifier units adapted to be respectively supplied with the plurality of divided audio signals from the signal divider unit, each of the plurality of amplifier units including a plurality of amplifier devices adapted to respectively amplify the plurality of divided audio signals with gains which are respectively set based on a window function set in each of the amplifier units, and a plurality of sound emission devices adapted to emit acoustic beams with directional characteristics based on the divided audio signals respectively amplified by the plurality of amplifier devices of each of the plurality of amplifier units, wherein the window functions for the plurality of amplifier units are set in such a manner that the window function for that one of the amplifier units which is supplied with the divided audio signal of higher frequency range provides the directional characteristic involving a larger number of local minimum points of acoustic beam intensity in a blocking zone of the directional characteristic, and the at least one set value for the signal divider unit is set in such a manner that the acoustic beam intensity at a predetermined directivity angle does not exceed a predetermined value.

The speaker array apparatus can further include a control unit adapted to change the directional characteristics of acoustic beams emitted from the plurality of sound emission devices, and the plurality of sound emission devices can include a plurality of delay devices adapted to perform delay processing on the amplified divided audio signals supplied from corresponding ones of the plurality of amplifier devices of the plurality of amplifier units, and a plurality of speakers adapted to emit sounds based on the divided audio signals subjected to the delay processing, and the control unit can control amounts of delay of the divided audio signals attained by the delay processing by the delay devices of the plurality of sound emission devices, thereby changing the directional characteristics of the acoustic beams.

The speaker array apparatus can further include a control unit adapted to change the directional characteristics of acoustic beams emitted from the plurality of sound emission devices, and each of the plurality of amplifier units of the signal processing unit can include a plurality of delay devices adapted to perform delay processing on the divided audio signals supplied from the signal divider unit to each of the plurality of amplifier units, the plurality of amplifier devices of each of the amplifier units can amplify the divided audio signals subjected to the delay processing by the plurality of delay devices of each of the amplifier units, and the control unit can control amounts of delay of the divided audio signals attained by the delay processing by the plurality of delay devices of each of the plurality of amplifier units, thereby changing the directional characteristics of the acoustic beams.

The speaker array apparatus can further include a change unit adapted to change the at least one set value for the signal divider unit in a case where the control unit changes the directional characteristics of acoustic beams by controlling the amounts of delay of the divided audio signals in the delay processing by the delay devices of the plurality of sound emission devices or by the delay devices of the plurality of amplifier units.

According to a second aspect of this invention, there is provided a microphone array apparatus comprising a plurality of sound pickup devices adapted to pick up sounds with directional characteristics and generate a plurality of audio signals based on picked up sounds, a signal processing unit including a plurality of amplifier units adapted to be respectively supplied with the plurality of audio signals from the plurality of sound pickup devices, each of the plurality of amplifier units including a plurality of amplifier devices adapted to respectively amplify the plurality of audio signals with gains which are respectively set based on a window function set in each of the amplifier unit, each of the plurality of amplifier units being adapted to add the plurality of amplified audio signals together to thereby generate an added audio signal, and a signal divider synthesizer unit including a plurality of frequency range selection devices adapted to be supplied with the added audio signals from the plurality of amplifier units and an adder device adapted to add output signals from the plurality of frequency range selection devices together, wherein the output signal from each of the plurality of frequency range selection devices includes those audio signal components of the added audio signal supplied to each of the frequency range selection devices whose frequencies fall within that one of a plurality of different frequency ranges divided at at least one set value in terms of frequency characteristic which corresponds to each of the frequency range selection devices, the window functions for the plurality of amplifier units are set in such a manner that the window function for that one of the amplifier units which is supplied with the audio signal of higher frequency range provides the directional characteristic involving a larger number of local minimum points of acoustic beam intensity in a blocking zone of the directional characteristic, and the at least one set value for the signal divider synthesizer unit is set in such a manner that the acoustic beam intensity at a predetermined directivity angle does not exceed a predetermined value.

According to a third aspect of this invention, there is provided a signal processing method for a speaker array apparatus including a plurality of sound emission devices, comprising a signal division step of dividing an audio signal supplied to the speaker array apparatus at at least one set value in terms of frequency characteristic into a plurality of audio signal components to thereby generate a plurality of divided audio signals of different frequency ranges, a signal processing step including a plurality of groups of amplification steps of being respectively supplied with the plurality of divided audio signals from the signal division step, each of the plurality of groups of amplification steps including a plurality of amplification steps of respectively amplifying the plurality of divided audio signals with gains which are respectively set based on a window function set for each of the plurality of groups of amplification steps, and a sound emission step of supplying the plurality of sound emission devices with the divided audio signals respectively amplified by the plurality of amplification steps of each of the plurality of groups of amplification steps and causing the plurality of sound emission devices to emit acoustic beams with directional characteristics, wherein the window functions for the plurality of groups of amplification steps are set in such a manner that the window function for that one of the groups of amplification steps which is supplied with the audio signal of higher frequency range provides the directional characteristic involving a larger number of local minimum points of acoustic beam intensity in a blocking zone of the directional characteristic, and the at least one set value for the signal division step is set in such a manner that the acoustic beam intensity at a predetermined directivity angle does not exceed a predetermined value.

According to a fourth aspect of this invention, there is provided a signal processing method for a microphone array apparatus including a plurality of sound pickup devices adapted to pick up sounds with directional characteristics and generate a plurality of audio signals based on picked up sounds, comprising a signal processing step including a plurality of groups of amplification steps of being respectively supplied with the plurality of audio signals from the plurality of sound pickup devices, each of the plurality of groups of amplification steps including a plurality of amplification steps of respectively amplifying the plurality of audio signals with gains which are respectively set based on a window function set in each of the plurality of groups of amplification steps, a plurality of the amplified audio signals being added together to generate an added audio signal in each of the plurality of groups of amplification steps, and a signal division synthesis step including a plurality of frequency range selection steps of being supplied with the added audio signals from the plurality of groups of amplification steps and an addition step of adding output signals from the plurality of frequency range selection steps together, wherein the output signal from each of the plurality of frequency range selection steps includes those audio signal components of the added audio signal supplied to each of the frequency range selection steps whose frequencies fall within that one of a plurality of different frequency ranges divided at at least one set value in terms of frequency characteristic which corresponds to each of the frequency range selection steps, the window functions for the plurality of groups of amplification steps are set in such a manner that the window function for that one of the groups of amplification steps which is supplied with the audio signal of higher frequency range provides the directional characteristic involving a larger number of local minimum points of acoustic beam intensity in a blocking zone of the directional characteristic, and the at least one set value for the signal division synthesis step is set in such a manner that the acoustic beam intensity at a predetermined directivity angle does not exceed a predetermined value.

With the present invention, a speaker array apparatus, a microphone array apparatus, and a signal processing method can be provided, which make it possible to carry out directivity control over a wide frequency range with a reduced processing load.

Further features of the present invention will become apparent from the following description of exemplary embodiments with reference to the attached drawings.

### BRIEF DESCRIPTION OF THE DRAWINGS

FIG. 1 is a block diagram showing the construction of a speaker array apparatus according to a first embodiment of this invention;

FIG. 2 is a block diagram showing the construction of a signal processing unit shown in FIG. 1;

FIG. 3 is a block diagram showing the construction of an amplifier unit shown in FIG. 2;

FIG. 4 is a block diagram showing the construction of a signal divider unit shown in FIG. 1;

FIG. 5A is a polar coordinate graph showing a directional characteristic of an acoustic beam emitted at a frequency of 879 Hz at which a window function is determined, the directional characteristic having local minimum points which are four in number;

FIG. 5B is a graph showing a directional characteristic of an acoustic beam emitted at a frequency of 872 Hz at which a window function is determined, the directional characteristic having four local minimum points;

FIG. 6 is a partly cut away view of the speaker array apparatus in which an axis extending in the zero degree direction of directivity angle is shown;

FIG. 7 is a graph showing a directional characteristic of an acoustic beam emitted at a frequency of 126 Hz at which a window function is determined, the directional characteristic having one local minimum point;

FIG. 8 is a graph showing a directional characteristic of an acoustic beam emitted at a frequency of 327 Hz at which a window function is determined, the directional characteristic having two local minimum points;

FIG. 9 is a graph showing a directional characteristic of an acoustic beam emitted at a frequency of 585 Hz at which a window function is determined, the directional characteristic having three local minimum points;

FIG. 10 is a graph showing a disordered directional characteristic of an acoustic beam emitted at 2000 Hz with a window function determined at 872 Hz;

FIG. 11 is a graph showing a directional characteristic of an acoustic beam emitted at 130 Hz with a window function determined at 126 Hz;

FIG. 12 is a graph showing a directional characteristic of an acoustic beam emitted at 140 Hz with the window function determined at 126 Hz;

FIG. 13 is a block diagram showing the construction of a sound emission unit according to a second modification;

FIG. 14 is a graph showing a directional characteristic of acoustic beam according to the second modification, with the directivity direction of the acoustic beam emitted at 126 Hz being changed by minus 5 degrees;

FIG. 15 is a block diagram showing the construction of an amplifier unit according to a fifth embodiment;

FIG. 16 is a block diagram showing connections between a signal divider unit, delay circuits, and a signal processing unit according to the fifth modification;

FIG. 17 is a block diagram showing the construction of an amplifier unit according to a sixth modification;

FIG. 18 is a block diagram showing the construction of a signal processing unit according to a seventh modification;

FIG. 19 is a block diagram showing the construction of a microphone array apparatus according to a second embodiment of this invention;

FIG. 20 is a block diagram showing the construction of a signal processing unit shown in FIG. 19;

FIG. 21 is a block diagram showing the construction of an amplifier unit shown in FIG. 20; and

FIG. 22 is a block diagram showing the construction of a signal divider synthesizer unit shown in FIG. 19.

### DETAILED DESCRIPTION OF THE PREFERRED EMBODIMENTS

The present invention will now be described in detail below with reference to the drawings showing preferred embodiments thereof.

### First Embodiment

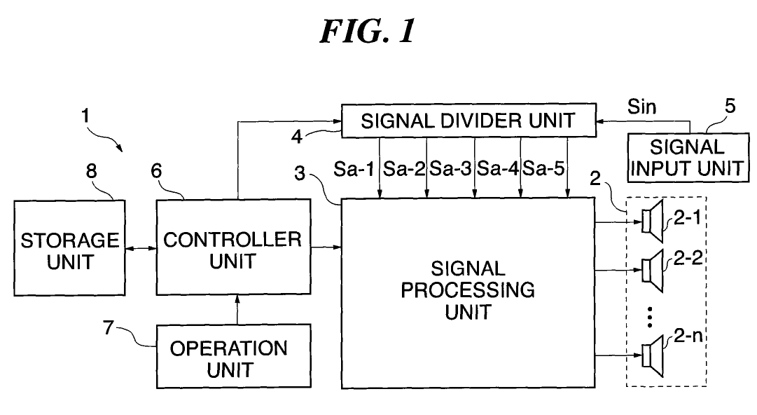

The following is a description of the construction of a speaker array apparatus 1 according to a first embodiment of this invention. FIG. 1 shows in block diagram the construction of the speaker array apparatus 1. A sound emission unit 2 of the apparatus 1 includes non-directional speakers 2-1 to 2-n disposed in line and directed to the same direction, and emits sounds based on audio signals supplied from a signal processing unit 3. Based on audio signals subjected to the below-mentioned signal processing, the speakers 2-1 to 2-n of the sound emission unit 2 emit acoustic beams of predetermined directional characteristics.

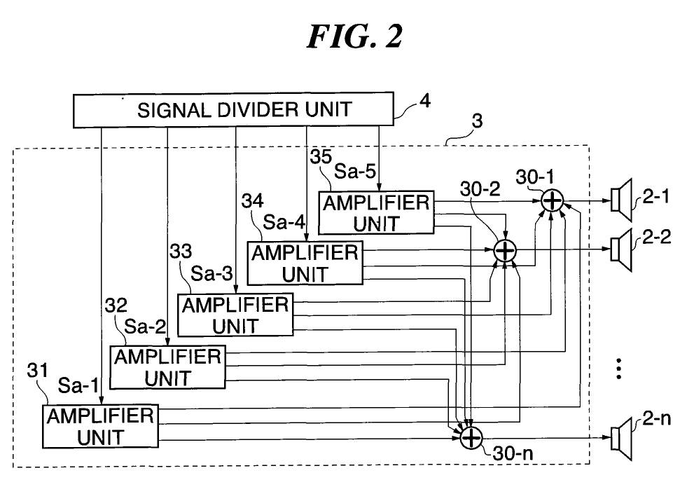

As shown in FIG. 2, the signal processing unit 3 includes amplifier units 31 to 35 and adders 30-1 to 30-n. The amplifier units 31 to 35 have the same construction. Among these, the amplifier unit 31 will be explained by way of example.

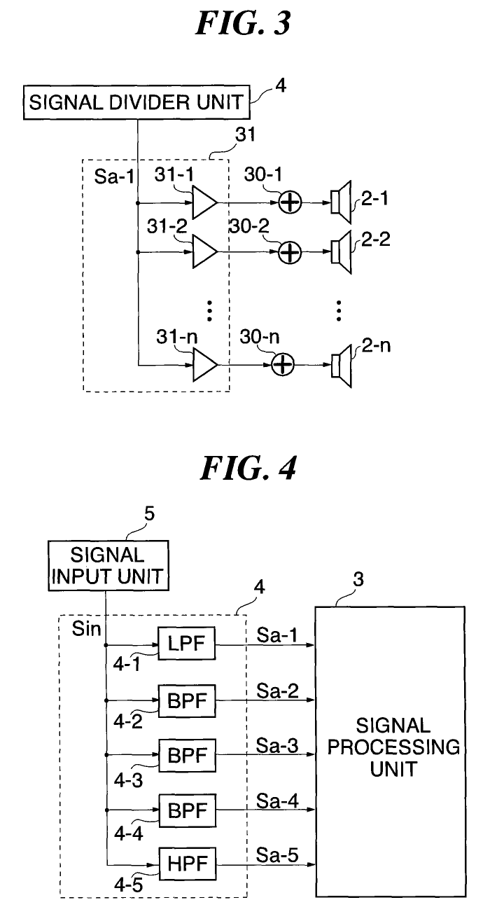

As shown in FIG. 3, the amplifier unit 31 includes amplifier circuits 31-1 to 31-n connected to the speakers 2-1 to 2-n via the adders 30-1 to 30-n. The amplifier circuits 31-1 to 31-n amplify an audio signal Sa-1 input from a signal divider unit 4 at gains set to the amplifier circuits, and supply the amplified audio signals to the speakers 2-1 to 2-n via the adders 30-1 to 30-n. Hereinafter, the way of setting the gains to the amplifier circuits 31-1 to 31-n will be referred to as a window function.

As described above, the amplifier units 31 to 35 each perform amplification processing on a corresponding one of audio signals Sa-1 to Sa-5 of five channels supplied from the signal divider unit 4 in accordance with the window function set to each of the amplifier units 31 to 35, and supply the amplified audio signals to the speakers 2-1 to 2-n via the adders 30-1 to 30-n. As a result, the speaker 2-1 emits sound in accordance with an audio signal obtained by the adder 30-1 by adding together audio signals output from the respective amplifier circuits 31-1 of the amplifier units 31 to 35. The speaker 2-2 emits sound in accordance with an audio signal obtained by the adder 30-2 by adding audio signals output from the respective amplifier circuits 31-2 of the amplifier units 31 to 35. This also applies to the speakers 2-3 to 2-n. The window functions set under the control of a controller unit 6 will be described later in detail.

Referring to FIG. 1 again, the signal divider unit 4 divides an audio signal Sin input from a signal input unit 5 into a plurality of different frequency range components to thereby generate divided audio signals Sa-1 to Sa-5, and supplies these signals to the amplifier units 31 to 35 of the signal processing unit 3.

With reference to FIG. 4, the construction of the signal divider unit 4 will be explained. As shown in FIG. 4, the signal divider unit 4 includes an LPF (low pass filter) 4-1, BPFs (band pass filters) 4-2, 4-3, and 4-4, and an HPF (high pass filter) 4-5.

The LPF 4-1 attenuates in amplitude signal components of the input audio signal Sin which have frequencies not less than a set frequency f1 to obtain the divided audio signal Sa-1, and supplies the signal Sa-1 to the amplifier unit 31 of the signal processing unit 3. The BPFs 4-2 to 4-4 attenuate in amplitude signal components of the input audio signal Sin which have frequencies falling outside set frequency ranges (from a lower limit frequency f1 to an upper limit frequency f2 for the BPF 4-2, from a lower limit frequency f2 to an upper limit frequency f3 for the BPF 4-3, and from a lower limit frequency f3 to an upper limit frequency f4 for the BPF 4-4) to thereby generate the divided audio signals Sa-2 to Sa-4, and supply the signals Sa-2 to Sa-4 to the amplifier units 32 to 34 of the signal processing unit 3, respectively. The HPF 4-5 attenuates in amplitude signal components the input audio signal Sin which have frequencies not greater than the set frequency f4 to obtain the divided audio signal Sa-5, and supplies the signal Sa-5 to the amplifier unit 35 of the signal processing unit 3. The set frequencies f1 to f4 have a relation of f1<f2<f3<f4 therebetween. The divided audio signals supplied from the signal divider unit 4 are named as Sa-1 to Sa-5 in the ascending order in terms of frequency range. The frequencies of the audio signals are set under the control of the controller unit 6 as will be described later.

Referring to FIG. 1 again, the controller unit 6 controls various units of the speaker array apparatus 1 as described above. The control can be carried out in accordance with set values input by a user by operating the operation unit 7 or in accordance with set values stored in a storage unit 8. The set values include, for example, the window functions to be set to the amplifier units 31 to 35 of the signal processing unit 3, the frequencies f1 to f4 to be set to the signal divider unit 4, the directional characteristics of acoustic beams, etc. In a case where plural sets of set values are stored in the form of a lookup table in the storage unit 8, the controller unit 6 can control various units of the speaker array apparatus 1 in accordance with that one of the plural sets of set values stored in the storage unit 8 which is selected by a user by operating the operation unit 7.

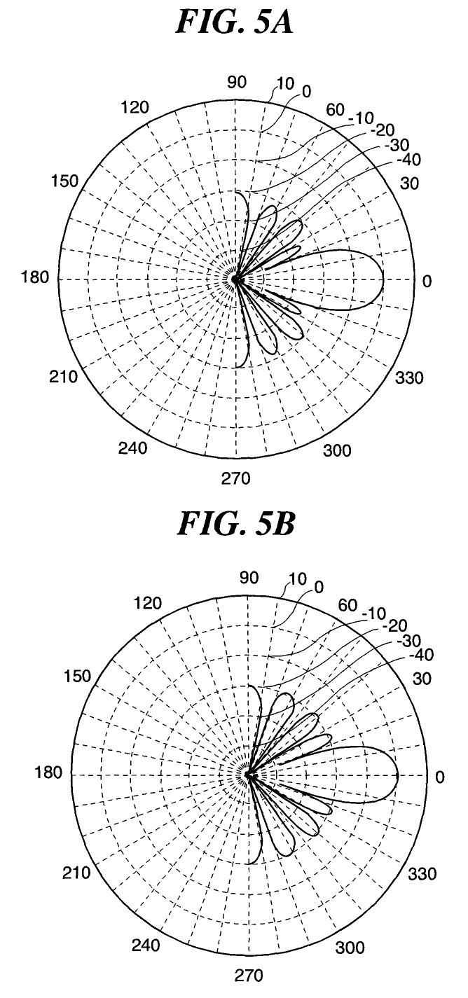

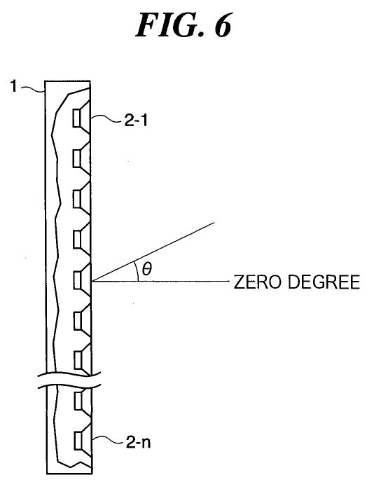

Next, a description will be given of the window functions, which are set to the amplifier units 31 to 35 of the signal processing unit 3 under the control of the controller unit 6. First, a plurality of candidates of window functions to be set to the amplifier units 31 to 35 are determined. The candidate window functions are determined by a known filter design technique in a condition that variables in the speaker array apparatus 1 such as speaker distances are set to desired values. In the following example, a filter design technique based on nonlinear optimization at a plurality of frequencies (which are preferably set at intervals of several Hz) will be described, but another technique based on least-square method or other method may be used. Next, directional characteristics of acoustic beams attained by the candidate window functions are determined. For example, a directional characteristic of acoustic beam shown in FIG. 5A is attained in a case that a window function determined by nonlinear optimization at a frequency of 879 Hz is set in the signal processing unit 3 and sound of the frequency of 879 Hz is emitted from the sound emission unit 2. FIG. 5A is a polar coordinate graph which shows a relation between acoustic beam intensity and directivity angle and in which the beam intensity (indicated in dB relative to a reference intensity measured in the zero-degree direction) is taken along the radial direction of the graph, and a directivity angle (measured from a zero degree axis extending perpendicular to a speaker front surface shown in FIG. 6) is taken along the circumferential direction of the graph. Similarly, a directional characteristic of acoustic beam shown in FIG. 5B is attained in a case where a window function determined by nonlinear optimization at a frequency of 872 Hz is set to the signal processing unit 3 and sound of the frequency of 872 Hz is emitted from the sound emission unit 2.

As described above, the number of local minimum points in blocking zones (i.e., angular zones where there is no main lobe whose intensity becomes large in the zero-degree direction) are the same between the directional characteristics of acoustic beam that are attained by window functions determined at frequencies which are close to each other. In the examples shown in FIGS. 5A and 5B, the number of local minimum points in a directivity angle zone in which the directivity angle varies from zero degree to 90 degrees is equal to 4. In the following, the “number of local minimum points in the directivity angle zone in which the directivity angle varies from zero degree to 90 degrees” will simply be referred to as the “number of local minimum points”.

From among the candidate window functions determined at various frequencies as described above, candidate window functions determined at those frequencies at which directional characteristics having the same number of local minimum points can be attained are selected as candidate window functions for one amplifier unit. From among the thus selected candidate window functions for the one amplifier unit, that one of them which can achieve a target directional characteristic (e.g., a directional characteristic having a main lobe width close to a target main lobe width) is selected as a window function to be set to the one amplifier unit.

For example, by comparing the acoustic beam directional characteristic attained based on the window function determined at the frequency of 879 Hz with that attained based on the window function determined at 872 Hz, it is understood that the window function determined at 872 Hz can provide a directional characteristic having a narrower main lobe width. Thus, the window function determined at 872 Hz is set as a window function for one amplifier unit. Similarly, other window functions for other amplifier units are determined from other candidate window functions.

By determining the optimum window functions as described above, it is possible to attain, for example, a directional characteristic having a main lobe width as narrow as possible under the requirement that the number of local minimum points remains the same. In addition, the same window function can be used for emission of sounds of frequencies at which the number of local minimum points remains the same, and therefore, the number of divisions of frequency range can be reduced.

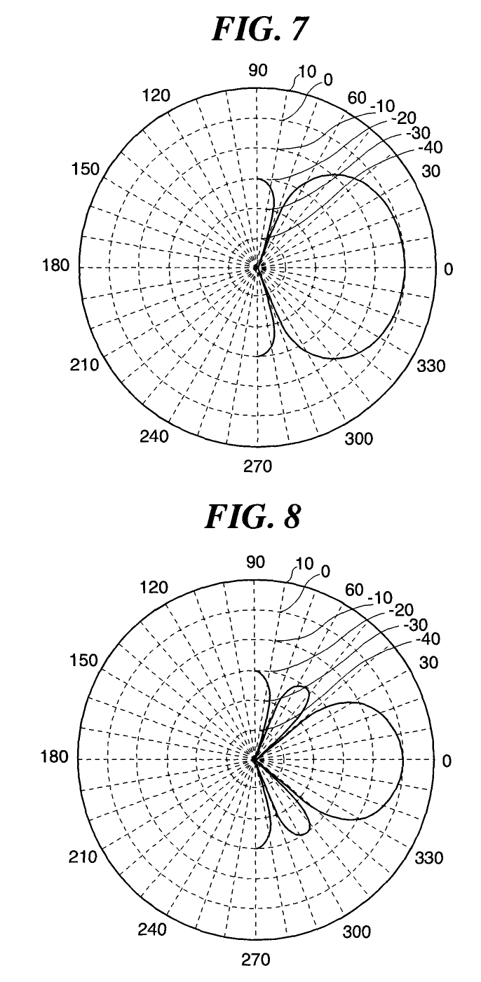

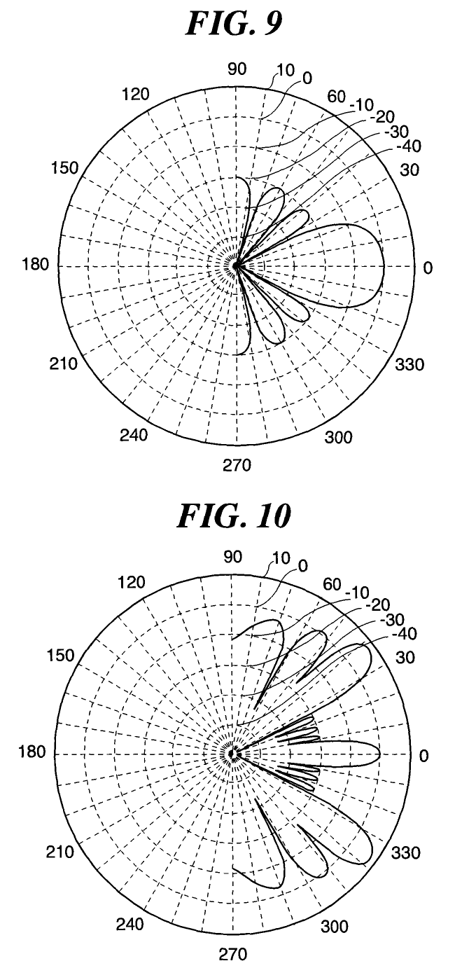

FIGS. 7 to 9 show directional characteristics of acoustic beams respectively attained in cases that the sound emission unit 2 emits sounds of frequencies of 126 Hz, 327 Hz, and 585 Hz at which the window functions are determined. In the example shown in FIG. 5, the number of local minimum points is 4. On the other hand, the numbers of local minimum points in the examples shown in FIGS. 7 to 9 are 1, 2, and 3, respectively.

A window function that realizes a direction characteristic which is low in number of local minimum points is set to an amplifier unit supplied with an audio signal of a low frequency range. For example, a window function determined at a frequency of 126 Hz (and providing a characteristic with one local minimum point) is set to the amplifier unit 31, and a window function determined at a frequency of 327 Hz (and providing a characteristic with two local minimum points) is set to the amplifier unit 32. Under the control of the controller unit 6, window functions are set to the amplifier units 31 to 35 as described above. The speakers 2-1 to 2-n in this embodiment are non-directional speakers, but may be speakers with directional characteristics. In that case, the window functions can be determined in accordance with the directional characteristics of the speakers 2-1 to 2-n.

Next, a description will be given of the frequencies f1 to f4, which are set to the signal divider unit 4 under the control of the controller unit 6. The audio signal Sa-1 of a frequency range having an upper limit frequency f1 is supplied to the amplifier unit 31 to which the window function determined at a frequency of 126 Hz is set. In the case of sound of 126 Hz being emitted from the sound emission unit 2, an acoustic beam with the directional characteristic shown in FIG. 7 is attained. It is assumed here that sounds of various frequencies are emitted, with the above described window function set to the amplifier unit. When sound of a frequency range lower than 126 Hz is emitted, the main lobe width of the resultant directional characteristic becomes broad, whereas the main lobe width becomes narrow when sound of frequency range higher than 126 Hz is emitted. In addition, in the case of sounds of high frequency range being emitted, the directional characteristic is disordered such as for example that the intensity of side lobe other than the main lobe increases. For example, when sound of 2000 Hz is emitted from the sound emission unit 2 with the window function determined at a frequency of 872 Hz set to the amplifier unit, an acoustic beam with a disordered directional characteristic as shown in FIG. 10 is emitted.

As described above, the directional characteristic of acoustic beam is disordered with increase in the intensity of side lobe. To obviate this, the frequency characteristics of the amplifier units 31 to 35 must be adjusted. Although there are various adjustment methods, it is necessary to determine the frequency characteristics in such a manner that the intensity of acoustic beam in the direction of a predetermined directivity angle does not exceed a predetermined value. In this embodiment, it is assumed that the predetermined directivity angle is equal to 90 degrees and the predetermined value is equal to −10 dB. The predetermined directivity angle and the predetermined value are not limitative thereto and may be changed so as to attain desired directional characteristics. Such changes can be carried out by a user by operating the operation unit 7.

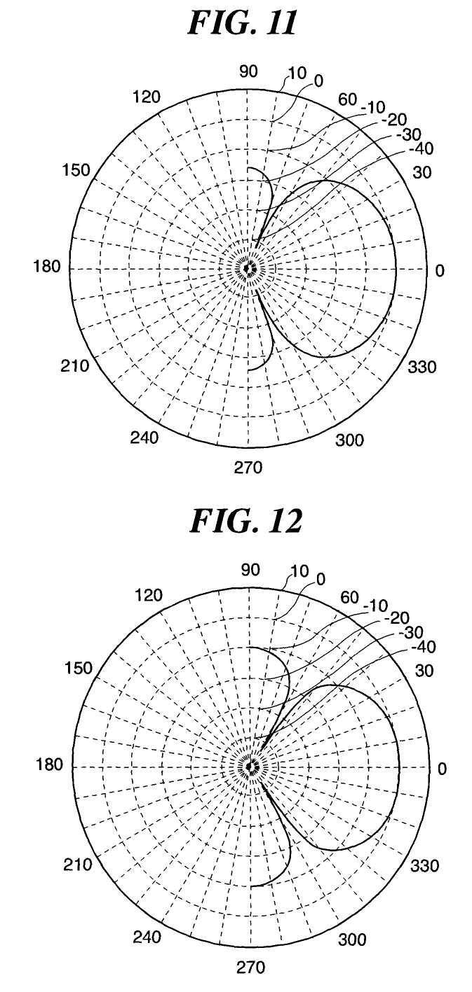

Specifically, the frequency f1 is determined as described below. FIGS. 11 and 12 show directional characteristics of acoustic beams attained in cases that sound of a frequency of 130 Hz and sound of 140 Hz are emitted from the sound emission unit 2, respectively, with the window function determined at a frequency of 126 Hz being set to the amplifier unit 31. As described above, the main lobe width becomes narrower when sound of the frequency of 130 Hz is emitted than when sound of the frequency of 126 Hz is emitted, and the main lobe width becomes much narrower when sound of the frequency of 140 Hz is emitted. With increase in sound emission frequency, the intensity of side lobe increases. The intensity of acoustic beam at a directivity angle of 90 degrees is −14 dB in the example of FIG. 11 and is −10 dB in the example of FIG. 12. When the window function determined at the frequency of 126 Hz is set to the amplifier unit 31, therefore, the upper limit of the frequency range of the input audio signal Sa-1 is determined to be 140 Hz. In this manner, the frequency f1 set in the signal divider unit 4 is set to 140 Hz under the control of the controller unit 6. In that case, an output from the amplifier unit 31 to which the window function determined at the frequency of 126 Hz is set is slightly attenuated at the frequency f1 (=140 Hz). The output from the amplifier unit 31 sometimes includes the contribution of an output from the amplifier unit 32 to which the window function determined at a higher frequency of 327 Hz is set. In a strict sense, therefore, the frequency characteristics of respective filters of the signal divider unit 4 may be determined in such a manner that the intensity of acoustic beam at a particular directivity angle does not exceed a predetermined value, in consideration of the frequency characteristics of audio signals output from the signal divider unit 4 and results of processing with the window functions, and, if necessary, directional characteristics of the speakers. By designing the filters as linear phase FIR filters based on a window function method, Fourier series approximation, or other technique, the frequency characteristics of divided audio signals generated by the signal divider unit 4 can be suppressed from being disordered at transient zones.

The frequency f2 relating to the frequency characteristic of the audio signal Sa-2 is determined in accordance with the window function set to the amplifier unit 32 as explained above, and is set to the signal divider unit 4 under the control of the controller unit 6. The frequencies f3 and f4 are set in a similar manner. Under the control of the controller unit 6, the frequencies f1 to f4 are set to the signal divider unit 4.

Next, a description will be given of operations of the speaker array apparatus 1 with the window functions set in the signal processing unit 3 and the frequencies f1 to f4 set in the signal divider unit 4 from when an audio signal Sin is input to the signal input unit 5 to when sounds are emitted from the sound emission unit 2.

The audio signal Sin input from the signal input unit 5 is output to the signal divider unit 4. In the signal divider unit 4, the audio signal Sin is distributed to the LPFs 4-1, the BPFs 4-2 to 4-4, and the HPF 4-5, and is divided into components of different frequency ranges in accordance with the set frequencies f1 to f4, whereby divided audio signals Sa-1 to Sa-5 are generated and supplied to the signal processing unit 3.

The divided audio signal Sa-1 from the signal divider unit 4 is supplied to the amplifier unit 31 of the signal processing unit 3, is subjected to amplification processing by the amplifier circuits 31-1 to 31-n with gains set based on the set window function, and is supplied via the adders 30-1 to 30-n to the speakers 2-1 to 2-n. Similarly, the other divided audio signals Sa-2 to Sa-5 are subjected to amplification processing in the amplifier units 32 to 35 with gains set based on the set window functions, and are supplied via the adders 30-1 to 30-n to the speakers 2-1 to 2-n. At that time, audio signals from those amplifier circuits of the amplifier units 31 to 35 which are connected to the same speaker are added together in the corresponding adders and then supplied to the speaker.

As described above, the audio signal Sin input from the signal input unit 5 is divided into frequency range components in the signal divider unit 4 to generate divided audio signals of different frequency ranges, which are then subjected to the amplification processing with gains determined based on the window functions set to the amplifier units 31 to 35 of the signal processing unit 3, and the sound emission unit 2 emits sounds in accordance with the amplified divided audio signals. As a result, desired directional characteristics can be attained over a wide frequency range. In addition, since it is unnecessary to finely divide the entire frequency range, an amount of calculation for the signal processing in the signal processing unit 3 can be reduced, whereby directivity control over a wide frequency range can be carried out with reduced processing load.

In the above, the first embodiment of this invention has been described. As will be described below, this invention can be carried out in various manners.

First Modification

In the above described first embodiment, the signal divider unit 4 divides the input audio signal Sin at the four frequencies f1 to f4 to thereby generate the divided audio signals Sa-1 to Sa-5 of five frequency ranges. However, the number of the divided audio signals generated by division of the input audio signal Sin is not limited to five, but may be an arbitrary number which is equal to or greater than two. In that case, the number of amplifier units of the signal processing unit 3 can be increased or decreased in accordance with the number of the divided audio signals generated by division. The number of divisions can be calculated based on a desired directional characteristic, the number of speakers of the sound emission unit 2, the result of nonlinear optimization, etc.

Second Modification

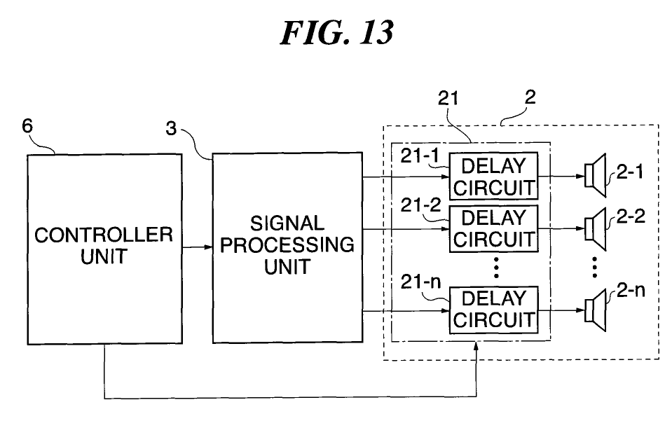

In the first embodiment, directivity control is carried out by performing amplification processing based on window functions set to the amplifier units 31 to 35 of the signal processing unit 3, and therefore, the main lobe direction (hereinafter referred to as the directivity direction) of acoustic beam cannot be controlled. However, it is possible to control the directivity direction. To this end, as shown in FIG. 13, the sound emission unit 2 can be provided with a delay unit 21 including delay circuits 21-1 to 21-n that perform delay processing with set amounts of delay on audio signals supplied from the signal processing unit 3. Based on the directivity direction instructed by a user by operating the operation unit 7, the controller unit 6 calculates amounts of delay of the audio signals. Under the control of the controller unit 6, the calculated amounts of delay are set to the delay circuits 21-1 to 21-n of the delay unit 21. It is not inevitably necessary that the directivity direction be instructed by the user. The directivity direction can be determined in accordance with various information on changes in directivity direction, etc. stored in the storage unit 8.

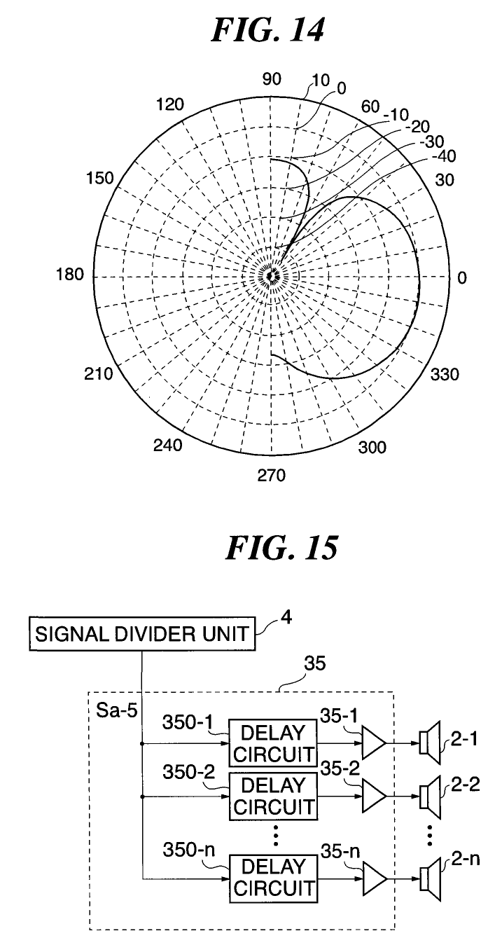

In a case where the directivity direction is caused to change, for example, in a case where the directivity direction of the acoustic beam emitted at 126 Hz as shown in FIG. 7 is caused to change by minus 5 degrees, a large change in the acoustic beam intensity at 90 degrees can sometimes occur as shown in FIG. 14. In that case, the frequencies f1 to f4 set to the signal divider unit 4 may be changed so as to satisfy the above described condition under the control of the controller unit 6. It should be noted that window functions set to the amplifier units 31 to 35 of the signal processing unit 3 can be changed by the above described method under the control of the controller unit 6.

Third Modification

In the case of the delay unit 21 being provided as in the second modification, the directional characteristic control in the first embodiment can be carried out by setting amounts of delay to the delay circuits 21-1 to 21-n so that the acoustic beam is focused. In that case, the directional characteristic of the main lobe can be disordered in a high frequency range. To obviate this, the signal input unit 5 can be made to have a frequency dependency to realize an equalizer function for amplitude adjustment, and the dependency of amplitude to frequency can be adjusted so as to prevent the directional characteristic from being disordered. It should be noted that the equalizer function can be achieved by the LPF 4-1, the BPFs 4-2 to 4-4, and the HPF 4-5 of the signal divider unit 4, and the amplitudes of audio signal components of predetermined frequency ranges which can pass through the filters can be adjusted.

Fourth Modification

In the first embodiment, the signal divider unit 4 is provided with the LPF 4-1 to attain the audio signal Sa-1 of the lowest frequency range and provided with the HPF 4-5 to attain the audio signal Sa-5 of the highest frequency range. Instead of one or both of the LPF 4-1 and the HPF 4-5, one or more BPFs can be used. In the case of using a BPF alternative to the LPF 4-1, a lower limit of the frequency range must be determined, and in the case of using a BPF alternative to the HPF 4-5, an upper limit of the frequency range must be determined. The lower and upper limits may be determined based on the audible frequency range or based on the frequency characteristic of audio signal Sin and a frequency range for use in sound emission. The lower and upper limits may be determined in advance or may be instructed by a user by operating the operation unit 7. In a case that the lower and upper limits are determined based on the frequency characteristic of the audio signal Sin, the signal input unit 5 may be provided with a measurement unit for measuring the frequency characteristic of the audio signal Sin, and the controller unit 6 may determine the lower and upper limits based on the frequency characteristic measured by the measurement unit.

Fifth Modification

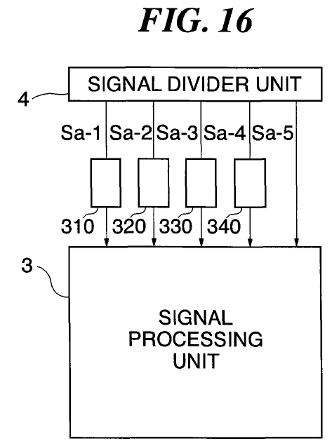

In the first embodiment, the main lobe widths of acoustic beams can sometimes be made excessively narrow at high frequencies with the window functions set to the amplifier units 31 to 35 (in particular, a window function set to an amplifier unit of a high frequency range (the amplifier unit 35 in the embodiment)). To obviate this, as shown in FIG. 15, there may be provided delay circuits 350-1 to 350-n for performing delay processing on audio signals input to the amplifier unit 35 for adjustment of directional characteristic, whereby the delay processing on frequency ranges can individually be carried out. The delay circuits may be provided not only for an amplifier unit for performing audio signals of high frequency range but also for other amplifier units. If there occurs a phase interference in an overlapping frequency range between sounds emitted after being subjected to delay processing by the delay circuits 350-1 to 350-n and sounds emitted without being subjected to delay processing, there may be provided delay circuits 310 to 340 that perform delay processing on input audio signals, as shown in FIG. 16, for adjustment of amounts of delay of these signals so as to reduce affections of the phase interference. It should be noted that the directivity direction of acoustic beam can be changed as in the second modification by providing the above described delay circuits for all the amplifier units. In a case that the directional characteristic is disordered, the signal input unit 5 or the like may be made to have an equalizer function, as described in the third modification, for adjustment of the dependency of amplitude to frequency.

Sixth Modification

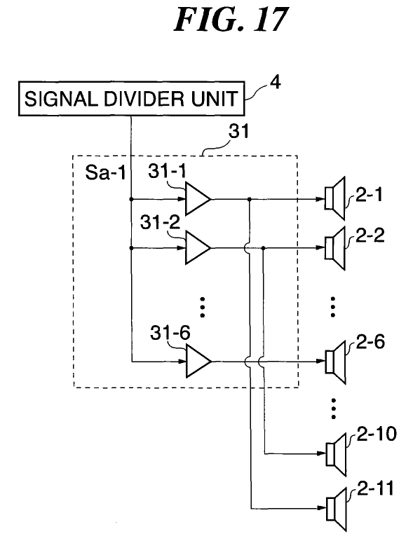

In the first embodiment, each of the amplifier units 31 to 35 includes the amplifier circuits which are equal in number to the speakers of the sound emission unit 2. If the window function set to each amplifier unit has a symmetry, the number of amplifier circuits can be reduced according to the symmetry, whereby an amount of calculation for the processing in the signal processing unit 3 can be reduced. In a case for example where the speakers are 11 in number and outputs of the speakers 2-1 to 2-11 are symmetric with respect to the speaker 2-6, the amplifier unit 31 may have amplifier circuits 31-1 to 31-6 each of which is connected to two speakers from which the same output is output as shown in FIG. 17, whereby the number of the amplifier circuits can be reduced from 11 to 6 and the processing load on the signal processing unit 3 can be reduced.

Seventh Modification

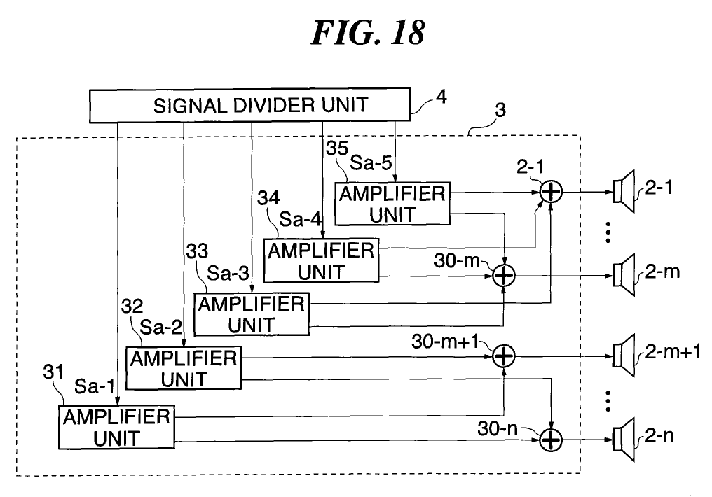

In the first embodiment, the sound emission unit 2 includes the speakers 2-1 to 2-n which are the same as one another. Alternatively, the sound emission unit 2 may be comprised, for example, of speakers 2-1 to 2-m, which are small in diameter and suitable to output sounds of high frequency range, and speakers 2-m+1 to 2-n, which are large in diameter and suitable to output sounds of low frequency range. In that case, as shown in FIG. 18, audio signals Sa-1 and Sa-2 of low frequency ranges amplified by the amplifier units 31, 32 of the signal processing unit 3 may be added together by adders 30-m+1 to 30-n and outputs of these adders may be supplied to the speaker 2-m+1 to 2-n. On the other hand, audio signals Sa-3 to Sa-5 of high frequency ranges amplified by the amplifier units 33 to 35 may be added together by adders 30-1 to 30-m and outputs of these adders may be supplied to the speakers 2-1 to 2-m. With this arrangement, the degree of freedom of acoustic beam directivity control can be enhanced, whereby the main lobe width of an acoustic beam of low frequency range can be made narrower, for instance.

Eighth Modification

In the first embodiment, the signal processing unit 3 performs amplification processing on audio signals of all the frequency ranges. Alternatively, audio signals of only part of frequency ranges may be subjected to the amplification processing. In that case, audio signals of other frequency ranges not subjected to the amplification processing by the signal processing unit 3 may be subjected to signal processing by FIR filters in which phases and amplitudes of the audio signals are changed to carry out directivity control of acoustic beams of those frequency ranges. For example, only the audio signal Sa-5 is subjected to signal processing with dependency to frequency by an FIR filter, whereby high frequency components of an audio signal supplied to a speaker positioned at an end of the speaker array can be attenuated. With the signal processing by FIR filters, frequency characteristics of audio signals supplied to speakers can individually be changed, whereby a desired directional characteristic can be attained.

Ninth Modification

In the first embodiment, window functions to be set to the amplifier units 31 to 35 of the signal processing unit 3 are selected from candidate window functions determined according to the numbers of local minimum points in directional characteristics, and a window function that provides a directional characteristic with a smaller number of local minimum points is set to an amplifier unit for lower frequency range, whereas a window function that provides a directional characteristic with a larger number of local minimum points is set to an amplifier unit for higher frequency range. It is assumed in the first embodiment that the number of local minimum points is increased one by one, however, this is not limitative. For example, instead of a window function determined at a frequency of 327 Hz (which provides a directional characteristic with two local minimum points), a window function determined at a frequency of 587 Hz (which provides a directional characteristic with three local minimum points) may be set to the amplifier unit 32. In that case, the frequency range of the audio signal Sa-2 is broadened to include frequencies from f1 to f3, which corresponds to the frequency ranges of the audio signals Sa-2 and Sa-3 in the first embodiment. Since the upper limit of the frequency range from f1 to f3 is originally equal to f3 (=585 Hz), the directional characteristic is not disordered even if the window function determined at 585 Hz is set to the amplifier unit 32. With this arrangement, the frequency range of one amplifier unit is made broad, and therefore, the number of amplifier units and the processing load on the signal processing unit 3 can be reduced.

Tenth Modification

In the first embodiment, the controller unit 6 controls the signal processing unit 3 and the signal divider unit 4 based on the set values input by a user by operating the operation unit 7 and/or the set values stored in the storage unit 8 to thereby set the window functions to the signal processing unit 3 and set the frequencies f1 to f4 to the signal divider unit 4. Alternatively, the window functions and the frequencies f1 to f4 can be calculated based on desired directional characteristics and the calculated functions and frequencies can be set. In that case, the desired directional characteristics can be input by the user by operating the operation unit 7.

### Second Embodiment

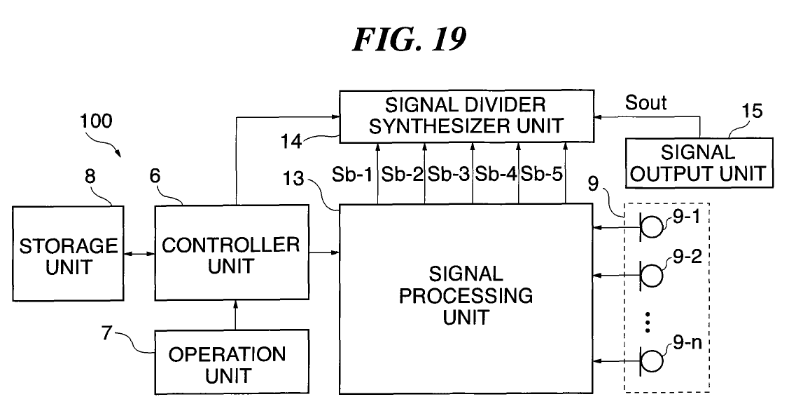

In the first embodiment, the speaker array apparatus 1 for emitting acoustic beams having desired directional characteristics has been described. However, this invention is applicable to a microphone array apparatus comprised of directional microphones having desired directional characteristics. With reference to FIGS. 19 to 22, a microphone array apparatus 100 according to a second embodiment of this invention will be described.

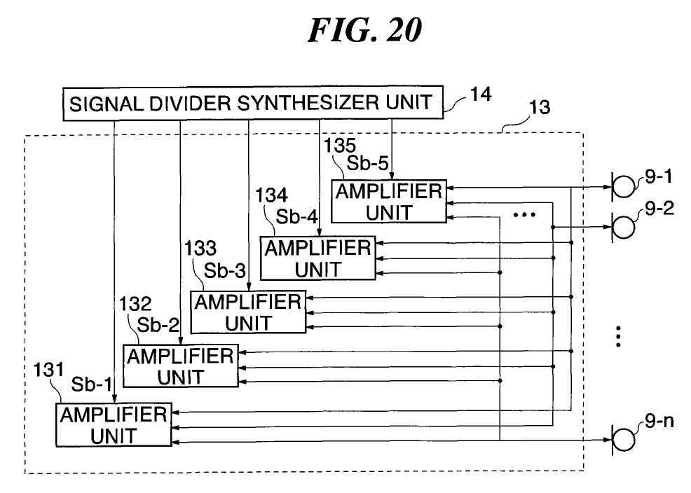

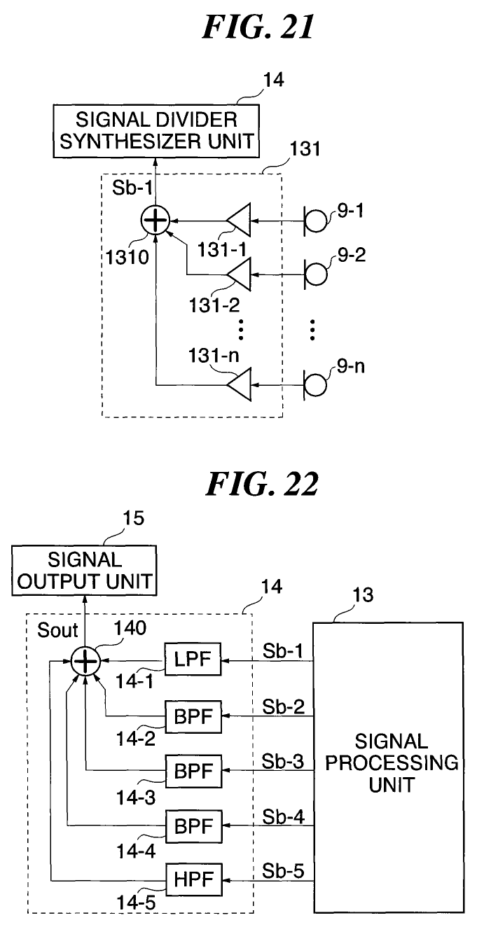

As shown in FIG. 19, the microphone array apparatus 100 includes a sound pickup unit 9 having non-directional microphones 9-1 to 9-n. The sound pickup unit 9 generates a plurality of audio signals based on sounds picked up by the microphones 9-1 to 9-n, and supplies the audio signals to a signal processing unit 13. As shown in FIG. 20, the signal processing unit 13 includes amplifier units 131 to 135, which are the same in construction. As shown in FIG. 21, the amplifier unit 131 includes amplifier circuits 131-1 to 131-n and an adder 1310. In the amplifier circuits 131-1 to 131-n, amplification processing on audio signals supplied from microphones 9-1 to 9-n is performed with gains determined based on a window functions set as described in the first embodiment. The audio signals amplified by and output from the amplifier circuits 131-1 to 131-n are added together by the adder 1310, and the resultant signal is supplied as an audio signal Sb-1 to a signal divider synthesizer unit 14.

As shown in FIG. 22, the signal divider synthesizer unit 14 includes an LPF 14-1, BPFs 14-2 to 14-4, an HPF 14-5, and an adder 140. The LPF 14-1, the BPFs 14-2 to 14-4, and the HPF 14-5 perform signal processing on audio signals supplied thereto on the basis of the set frequencies f1 to f4, as in the LPF 4-1, the BPFs 4-2 to 4-4 and the HPF 4-5 described in the first embodiment. The audio signal Sb-1 output from the signal processing unit 13 is supplied to the LPF 14-1, the audio signals Sb-2 to Sb-4 are supplied to the BPFs 14-2 to 14-4, respectively, and the audio signal Sb-5 is supplied to the HPF 14-5. The audio signals of different frequency ranges which are signal-processed by the LPF 14-1, the BPFs 14-2 to 14-4, and the HPF 14-5 are added together by the adder 140, and the resultant signal is output as an audio signal Sout to a signal output unit 15.

In the following, the window functions set to the amplifier units 131 to 135 of the signal processing unit 13 and the frequencies f1 to f4 set to the signal divider synthesizer unit 14 will be described in this order. First, the window functions set to the amplifier units 131 to 135 of the signal processing unit 13 under the control of the controller unit 6 will be described.

As in the first embodiment, candidates of the window functions to be set to the amplifier units 131 to 135 are determined. Under a condition that variables in the microphone array apparatus 100 such as microphone distances are set to desired values, a plurality of candidate window functions are determined by nonlinear optimization at a plurality of frequencies. From among the candidate window functions determined at various frequencies, candidate window functions determined at those frequencies at which directional characteristics of sound pickup having the same number of local minimum points can be attained are selected as candidate window functions for one amplifier unit. From among the thus selected candidate window functions for the one amplifier unit, that one of them which can achieve a target directional characteristic (e.g., a directional characteristic having a main lobe width close to a target main lobe width) is selected as a window function to be set to the one amplifier unit. Similarly, other window functions for other amplifier units are determined from other candidate window functions. The microphones 9-1 to 9-n in this embodiment are non-directional microphones, but may be microphones with directional characteristics. In that case, the window functions can be determined in accordance with the directional characteristics of the microphones 9-1 to 9-n.

Next, a description will be given of the frequencies f1 to f4, which are set to the signal divider synthesizer unit 14 under the control of the controller unit 6. As will be understood from the description in the first embodiment, if sounds of various frequencies are picked up using the window function set to one amplifier unit, the directional characteristic is disordered such as for instance that the intensity of side lobe other than the main lobe increases in high frequency range. To obviate this, upper frequency limits of the audio signals Sb-1 to Sb-4 output from the amplifier units 131 to 134 are determined so that directional characteristics are prevented from being disordered. Although there are various methods for determining the upper frequency limits, the upper frequency limits must be determined in such a manner that the intensity at a predetermined angle does not exceed a predetermined value.

With the above arrangement, the microphone array apparatus 100 is capable of carrying out sound pickup with predetermined directional characteristics. As in the first embodiment, an amount of calculation in signal processing can be reduced, and directivity control over a wide frequency range can be carried out with reduced processing load. It should be noted that the microphone array apparatus 100 can be modified as in the first to tenth modifications of the first embodiment.

What is claimed is:

1. A speaker array apparatus comprising:
a signal divider unit adapted to divide an input audio signal at at least one set value in terms of frequency characteristic into a plurality of audio signal components to thereby generate a plurality of divided audio signals of different frequency ranges;
a signal processing unit including a plurality of amplifier units adapted to be respectively supplied with the plurality of divided audio signals from said signal divider unit, each of said plurality of amplifier units including a plurality of amplifier devices adapted to respectively amplify the plurality of divided audio signals with gains which are respectively set based on a window function set in said each of said amplifier units; and
a plurality of sound emission devices adapted to emit acoustic beams with directional characteristics based on the divided audio signals respectively amplified by the plurality of amplifier devices of each of said plurality of amplifier units,
wherein the window functions for said plurality of amplifier units are set in such a manner that the window function for that one of the amplifier units which is supplied with the divided audio signal of higher frequency range provides the directional characteristic involving a larger number of local minimum points of acoustic beam intensity in a blocking zone of the directional characteristic, and
the at least one set value for said signal divider unit is set in such a manner that the acoustic beam intensity at a predetermined directivity angle does not exceed a predetermined value.

2. The speaker array apparatus according to claim 1, further including:
a control unit adapted to change the directional characteristics of acoustic beams emitted from said plurality of sound emission devices,
wherein said plurality of sound emission devices include a plurality of delay devices adapted to perform delay processing on the amplified divided audio signals supplied from corresponding ones of the plurality of amplifier devices of said plurality of amplifier units, and a plurality of speakers adapted to emit sounds based on the divided audio signals subjected to the delay processing, and
said control unit controls amounts of delay of the divided audio signals attained by the delay processing by the delay devices of said plurality of sound emission devices, thereby changing the directional characteristics of the acoustic beams.

3. The speaker array apparatus according to claim 1, further including:
a control unit adapted to change the directional characteristics of acoustic beams emitted from said plurality of sound emission devices,
wherein each of said plurality of amplifier units of said signal processing unit includes a plurality of delay devices adapted to perform delay processing on the divided audio signals supplied from said signal divider unit to said each of said plurality of amplifier units,
the plurality of amplifier devices of said each of said amplifier units amplify the divided audio signals subjected to the delay processing by the plurality of delay devices of said each of said amplifier units, and
said control unit controls amounts of delay of the divided audio signals attained by the delay processing by the plurality of delay devices of said each of said plurality of amplifier units, thereby changing the directional characteristics of the acoustic beams.

4. The speaker array apparatus according to claim 2, further including:
a change unit adapted to change the at least one set value for said signal divider unit in a case where said control unit changes the directional characteristics of acoustic beams by controlling the amounts of delay of the divided audio signals by the delay processing by the delay devices of said plurality of sound emission devices.

5. The speaker array apparatus according to claim 3, further including:
a change unit adapted to change the at least one set value for said signal divider unit in a case where said control unit changes the directional characteristics of acoustic beams by controlling the amounts of delay of the divided audio signals by the delay processing by the delay devices of said plurality of amplifier units.

6. A microphone array apparatus comprising:
a plurality of sound pickup devices adapted to pick up sounds with directional characteristics and generate a plurality of audio signals based on picked up sounds;
a signal processing unit including a plurality of amplifier units adapted to be respectively supplied with the plurality of audio signals from said plurality of sound pickup devices, each of said plurality of amplifier units including a plurality of amplifier devices adapted to respectively amplify the plurality of audio signals with gains which are respectively set based on a window function set in said each of said amplifier unit, said each of said plurality of amplifier units being adapted to add the plurality of amplified audio signals together to thereby generate an added audio signal; and
a signal divider synthesizer unit including a plurality of frequency range selection devices adapted to be supplied with the added audio signals from said plurality of amplifier units and an adder device adapted to add output signals from said plurality of frequency range selection devices together,
wherein the output signal from each of said plurality of frequency range selection devices includes those audio signal components of the added audio signal supplied to said each of said frequency range selection devices whose frequencies fall within that one of a plurality of different frequency ranges divided at at least one set value in terms of frequency characteristic which corresponds to said each of said frequency range selection devices,
the window functions for said plurality of amplifier units are set in such a manner that the window function for that one of the amplifier units which is supplied with the audio signal of higher frequency range provides the directional characteristic involving a larger number of local minimum points of acoustic beam intensity in a blocking zone of the directional characteristic, and
the at least one set value for said signal divider synthesizer unit is set in such a manner that the acoustic beam intensity at a predetermined directivity angle does not exceed a predetermined value.

7. A signal processing method for a speaker array apparatus including a plurality of sound emission devices, comprising:
a signal division step of dividing an audio signal supplied to the speaker array apparatus at at least one set value in terms of frequency characteristic into a plurality of audio signal components to thereby generate a plurality of divided audio signals of different frequency ranges;
a signal processing step including a plurality of groups of amplification steps of being respectively supplied with the plurality of divided audio signals from said signal division step, each of said plurality of groups of amplification steps including a plurality of amplification steps of respectively amplifying the plurality of divided audio signals with gains which are respectively set based on a window function set for said each of said plurality of groups of amplification steps; and
a sound emission step of supplying the plurality of sound emission devices with the divided audio signals respectively amplified by said plurality of amplification steps of said each of said plurality of groups of amplification steps and causing the plurality of sound emission devices to emit acoustic beams with directional characteristics,
wherein the window functions for said plurality of groups of amplification steps are set in such a manner that the window function for that one of the groups of amplification steps which is supplied with the audio signal of higher frequency range provides the directional characteristic involving a larger number of local minimum points of acoustic beam intensity in a blocking zone of the directional characteristic, and
the at least one set value for said signal division step is set in such a manner that the acoustic beam intensity at a predetermined directivity angle does not exceed a predetermined value.

8. A signal processing method for a microphone array apparatus including a plurality of sound pickup devices adapted to pick up sounds with directional characteristics and generate a plurality of audio signals based on picked up sounds, comprising:
a signal processing step including a plurality of groups of amplification steps of being respectively supplied with the plurality of audio signals from the plurality of sound pickup devices, each of said plurality of groups of amplification steps including a plurality of amplification steps of respectively amplifying the plurality of audio signals with gains which are respectively set based on a window function set in said each of said plurality of groups of amplification steps, a plurality of the amplified audio signals being added together to generate an added audio signal in said each of said plurality of groups of amplification steps; and
a signal division synthesis step including a plurality of frequency range selection steps of being supplied with the added audio signals from said plurality of groups of amplification steps and an addition step of adding output signals from said plurality of frequency range selection steps together,
wherein the output signal from each of said plurality of frequency range selection steps includes those audio signal components of the added audio signal supplied to said each of said frequency range selection steps whose frequencies fall within that one of a plurality of different frequency ranges divided at at least one set value in terms of frequency characteristic which corresponds to said each of said frequency range selection steps,
the window functions for said plurality of groups of amplification steps are set in such a manner that the window function for that one of the groups of amplification steps which is supplied with the audio signal of higher frequency range provides the directional characteristic involving a larger number of local minimum points of acoustic beam intensity in a blocking zone of the directional characteristic, and
the at least one set value for said signal division synthesis step is set in such a manner that the acoustic beam intensity at a predetermined directivity angle does not exceed a predetermined value.
